(19) United States
(12) Patent Application Publication
(10) Pub. No.: US 2011/0013085 A1
(43) Pub. Date: Jan. 20, 2011

(54) Method and Apparatus for Measuring Audio-Video Time skew and End-to-End Delay

(75) Inventor: Valentin Kulyk, Taby (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/933,101

(22) PCT Filed: Mar. 19, 2008
(86) PCT No.: PCT/EP2008/053327

§ 371 Date: Sep. 17, 2010

(51) Int. Cl. H04N 9/475

(52) U.S. Cl. 348/520; 348/512; 348/E09.034

(57) ABSTRACT

In a method and arrangement for determining time skew for a media sequence being conveyed from a sending party to a receiving party over a transmission path, first and second artificial media sequences (310; 306) are generated and added to individual captured media sequences (308; 304), resulting in a first and a second modified media sequence (308/310; 304/306), before being conveyed. At the receiving party, the modified media sequences (308′/310′; 304′306′) are presented and registered, and the artificial media sequences (310′; 306′) are extracted. The time difference between the extracted artificial media sequences (306′; 310′) is calculated as the time skew. Performing time skew determination by adding artificial media sequences to captured media sequences, extracting the artificial media sequences at the receiving party and comparing them can achieve an accurate determination including delays in the capturing and presentation devices.

### TECHNICAL FIELD

The present invention relates generally to time alignment of audio-video signals and in particular to calculating the audio-video skew and the End-to-End delay of such signals. Generally, it is also concerned with an audio-video capture device for capturing images and sounds, a transmission network, and an audio-video presentation device.

### BACKGROUND

In an audio-video transmission system, signals representing images and signals representing sounds from a scene are transferred in a transmission network between various users or user equipments. For such signal transmission, generally an audio-video capture device capturing images and sounds, a signal transmission network, and an audio-video presentation device are required. The signals are thus transferred in an audio-video transfer system that can be any system where audio-video signals representing images and sounds are transferred in a digital transmission network between two or more user equipments, e.g. Mobile TV, video telephony and IPTV (Internet Protocol TV).

“Lip sync” is the general term for the synchronisation between a video sequence and its corresponding audio sequence. The misalignment between video and audio is commonly referred to as “skew”. Viewing images and hearing sound unsynchronised is generally perceived as disturbing, especially if the misalignment is relatively large.

In FIG. 1a and FIG. 1b, respectively, an audio-video system and the timing of images and sound in the audio-video system are illustrated. Images and sound representing a scene 100 are captured by an audio-video capture device 102. The audio-video capture device 102 generates a video signal representing the images of the scene 100 and an audio signal representing the sound of the scene 100. For this purpose, the audio-video capture device is provided with means for capturing images as well as sounds, e.g. a CCD (Charged Coupled Device) for images and a microphone for sound. The audio signal and the video signal are transmitted over a transmission path 108 to an audio-video presentation device 110.

For presentation of the scene, the audio-video presentation device 110 is provided with means for presenting images as well as sounds, e.g. a display for images and a loudspeaker for sounds. The capture time Tcv for an image of the scene 100 is the moment when the audio-video capture device 102 captures the image, and the capture time Tca for a sound sample of the scene 100 is the moment when the audio-video capture device 102 records the sound sample. The capture times Tcv and Tca at the audio-video capture device 102 are substantially the same, i.e. the capture times Tcv and Tca are substantially simultaneous. The presentation time Tpv for the image is the moment when the audio-video presentation device 110 displays the image, and the presentation time Tpa for the sound sample is the moment when the audio-video presentation device emits the sound sample. The presented image and sound sample represents the captured image and sound sample, respectively.

Signals 106a representing an image captured by the image capturing means are schematically illustrated in FIG. 1b, together with signals 104a representing the corresponding captured sound. Due to various processing and buffering functions performed at different nodes on the audio signals and the video signals, the signals will be delayed. Propagation path delays will also affect the signals. In general, the audio signal will be less affected by delays than the video signal, due to the fact that the processing and the buffering of video signals require more processing capacity than the processing and the buffering of audio signals. Signals 106b used by the audio-video presenting device 110 for displaying an image and representing the captured image are schematically illustrated in FIG. 1b, together with corresponding sound signals 104b emitted by the audio-video presenting device, the sound signals representing the originally captured sound. The emitted sound signals 104b corresponds to the captured sound signals 104a delayed by a time Tpa, and the video signals image 106b for the displayed image corresponds to the captured image signals 106a delayed by a time Tpv. The difference between the image delay Tpv and the sound delay Ta is defined as the skew 112 and hence skew=Tpv−Tpa. The End-to-End delay E2E is illustrated at 114 and E2E=Tpv.

To be able to compensate for the delay of the signals representing images, there exists a need to determine the time skew of the audio-video sequence. Today there are generally some methods available for determining the skew, and these methods will be briefly described below. Today, there also exist some methods for delay determination. JP2001298757 discloses a method for time skew determination. Also JP2001326950, JP10-285483, and JP09093615 disclose methods for time skew determination.

However, there are certain problems associated with the existing solutions. For instance, none of them gives information regarding delays from the sending equipments and the receiving equipments.

### SUMMARY

It is an object of the present invention to address at least some of the problems outlined above. In particular, it is an object to provide a solution which allows an accurate determination of time alignment, for different media sequences when the media sequences are transferred over a transmission path. These objects and others may be achieved primarily by a solution according to the attached independent claims.

According to different aspects, a method and an arrangement are provided for determination of the time skew between a first media sequence and a second media sequence, when being conveyed from a sending party to a receiving party over a transmission path. In a method, at the sending party, a first artificial media sequence is generated and added to a captured first media sequence, resulting in a first modified media sequence. A second artificial media sequence is also generated and added to a second captured media sequence, resulting in a second modified media sequence. At the receiving party, the modified media sequences are registered and the artificial media sequences are extracted from them, respectively. Finally, the time difference between the extracted artificial media sequences is calculated as the time skew for the media sequences being conveyed over the transmission path. The artificial media sequences may be of the same or different media types. The media sequences may be an audio sequence and a video sequence, respectively, forming an audio-video sequence. An artificial media sequence may be implemented as detectable markers, e.g. coloured squares, coloured lines, coloured frames, or patterns comprising some predefined pixels. Additionally, an artificial media sequence may be implemented as a distinguishable audio sequence, e.g. an audio burst.

An arrangement for determining time skew comprises a test sequence generator at the sending party, and a time skew determination device at the receiving party. The test sequence generator comprises a first media sequence generator for generating a first artificial media sequence, and a second artificial media sequence generator for generating a second artificial media sequence. Furthermore, the test sequence generator is adapted to add the artificial media sequences to individual captured media sequences, resulting in modified media sequences to be fed to the receiving party. The time skew determination device comprises a first and a second sensor for registering and extracting a first and a second artificial media sequence, respectively, when presented at the receiving party. Moreover, the time skew determination device comprises a calculation unit for calculating the time difference between the extracted artificial sequences, as the time skew. Additionally, the media sequence generators may generate the artificial media sequences of the same or different media types.

According to further aspects, a method and an arrangement are provided for determination of the End-to-End delay for a media sequence being conveyed from a sending party to a receiving party over a transmission path. In a method, at the sending party, an artificial media sequence is generated and added to a captured media sequence, resulting in a modified media sequence. The modified media sequence is further presented at the sending party. Moreover, at the sending party, the modified media sequence is registered when presented, and the artificial media sequence is extracted from it. Correspondingly, at the receiving party, the modified media sequence is registered when presented, and the artificial media sequence is extracted therefrom. Finally, the time difference between the artificial media sequence extracted at the receiving party, and the artificial media sequence extracted at the sending party, is calculated as the End-to-End delay for the media sequence. The extracted artificial media sequence and the generated artificial media sequence may be of the same or different media types. The media sequence may be an audio sequence or a video sequence. An artificial media sequence may be implemented as detectable markers, e.g. coloured squares, coloured lines, coloured frames, or patterns comprising some predefined pixels. Additionally, an artificial media sequence may be implemented as a distinguishable audio sequence, e.g. an audio burst.

An arrangement for determining End-to-End delay comprises a test sequence generator at the sending party, and an End-to-End delay determination device. The test sequence generator comprises a media sequence generator for generation of an artificial media sequence. Furthermore, the test sequence generator is adapted to add the artificial media sequence to a captured media sequence, resulting in modified media sequences to be fed to the receiving party. Moreover, the test sequence generator comprises a presentation unit for presenting the modified media sequence. The End-to-End delay determination device comprises a first sensor for registering the modified media sequence when being presented at the sending party, and extracting the artificial media sequence therefrom. Furthermore, the End-to-End delay determination device comprises a second sensor for registering the modified media sequence when being received and presented at the receiving party, and extracting the artificial media sequence from it. Moreover, the End-to-End delay determination device comprises a calculation unit for calculating the time difference between the artificial sequence when presented at the receiving party, and the artificial media sequence when presented at the sending party, respectively, as the End-to-End delay. The sensors may convert the extracted artificial media sequence into a media type different from the generated artificial media sequence.

### BRIEF DESCRIPTION OF THE DRAWINGS

The present invention will now be described in more detail by means of exemplary embodiments and with reference to the accompanying drawings, in which:

FIG. 1a is a basic overview illustrating a scenario where an audio-video sequence is conveyed from a capturing device to a presentation device over a transmission path.

FIG. 1b is a diagram illustrating different delays of an audio-video sequence conveyed over a transmission path.

FIG. 2a is a block diagram illustrating a light-to-audio converter, in accordance with one embodiment.

FIG. 2b is a block diagram illustrating a sound-to-audio converter, in accordance with another embodiment.

FIG. 3 is a diagram illustrating a procedure for time skew determining of an audio-video sequence conveyed over a transmission path, in accordance with yet another embodiment.

FIG. 4 is a diagram illustrating a procedure for End-to-End delay determining of an audio-video sequence conveyed over a transmission path, in accordance with yet another embodiment.

FIG. 5 is a flow chart illustrating a method for time skew determining of an audio-video sequence conveyed over a transmission path, in accordance with yet another embodiment.

FIG. 6a is a block diagram illustrating a sending party of an arrangement for time skew determining of an audio-video sequence conveyed over a transmission path, in accordance with yet another embodiment.

FIG. 6b is a block diagram illustrating a receiving party of an arrangement for time skew determining of an audio-video sequence conveyed over a transmission path, in accordance with yet another embodiment.

FIG. 7 is a flow chart illustrating a method for End-to-End delay determining of a video sequence conveyed over a transmission path, in accordance with yet another embodiment.

FIG. 8 is a block diagram illustrating an arrangement for End-to-End delay determining of a video sequence conveyed over a transmission path, in accordance with yet another embodiment.

### DETAILED DESCRIPTION

Briefly described, the present invention provides a solution where a time skew determination device and an End-to-End delay determination device can achieve time skew determination and End-to-End delay determination for a media sequence, respectively, more accurately and less complex to determine. For time determination, a media test sequence is generated at a sending party, by providing a plurality of captured sub-sequences with artificial media sequences of the corresponding media types, resulting in a plurality of modified media sequences. The modified media sequences (media test sequence) are conveyed to a receiving party and presented. The time skew determination device then registers the presented modified media sequences and extracts the artificial media sequences. Finally, the artificial sequences are converted into the same media type and the time difference between them is calculated as the time skew.

For End-o-End delay determination, a media test sequence is generated at a sending party, by providing a captured media sequence with an artificial media sequence, resulting in a modified media sequence and presented. The modified media sequence is then conveyed to a receiving party and presented. The End-to-End delay determination device then registers the modified media sequence presented at the receiving party and the modified media sequence presented at the sending party and extracts the artificial media sequence on both parties. Finally, the artificial sequence at the receiving party and the artificial sequence at the sending party are converted into a different media type, and the time difference between them are calculated as the End-to-End delay.

When time skew occurs, the human mind is more sensitive to the case where a sound comes before the corresponding image, instead of the other way round. Since the speed of sound is less than the speed of light (about 340 m/s compared to 3×10⁸ m/s), the human mind is more used to receive an image before the corresponding sound. When transmitting an audio-video sequence over a transmission system, the audio signal will typically reach the presentation device before the video signal, due e.g. to the fact that the processing of images requires more processing capacity than the processing of sound.

The term “multimedia sequence” is used throughout this description to define a sequence comprising information in a plurality of media types. The applied media types in the embodiments described below are audio and video. However, any other suitable media types may be applied in the manner described, e.g. text or data information. Alternatively, the multimedia sequence may instead comprise two or more sub-sequences of the same media type, e.g. two sound sequences for stereophonic sound, a 3D-rendering comprising a plurality of audio sequences and a plurality of audio sequences, or a television sequence comprising a video sequence, an audio sequence and a text-line.

The term “video sequence” applied in the embodiments below, generally represents any video sequence being captured by an audio-video capturing device, or any video sequence to be presented on an audio-video presentation device. Video sequences of different kinds generally comprise different amounts of information that may require different bit rates for transmission. Furthermore, a rapidly varying and detailed scene typically requires a larger capacity for processing and buffering, than a slowly varying less detailed scene. Therefore, among other reasons, the rapidly varying and detailed scene will typically be more affected by delays. The term “audio sequence” applied in the embodiments below, generally represents the captured or presented audio sequence corresponding to a captured video sequence, or a video sequence to be presented. One advantage of the present invention is that it can be applied to various kinds of audio-video sequences.

The term “artificial audio” used in this description generally represents any detectable audio sequence suitable for being transformed into the video domain, and further suitable for being transmitted together with a captured audio sequence between two nodes. In the embodiments below, the artificial audio sequence is a burst, which is distinguishable from the captured audio sequence. However, the artificial audio sequence may be implemented as any other audio sequence which is distinguishable from the captured audio sequence. The term “artificial video” generally represents any detectable marker sequence, suitable for being combined with a captured video sequence into a modified video part of an audio-video test sequence. In this exemplary embodiment, the marker corresponding to an artificial audio sequence is implemented as a white square, and the marker corresponding to the absence of an artificial audio sequence is implemented as a black square. However, a person skilled in the art will realize that other types of markers can also be used. These markers may be visible or non-visible to a human person, and might for instance be a coloured square surrounding the image frame, a coloured line in one end of the image frame, or a pattern comprising some predefined pixels. The term “audio signal” denotes an electrical signal (analog or digital) representing a sound. Correspondingly, the term “video signal” denotes an electrical signal (analog or digital) representing one image, or a sequence of images. The term “registering” denotes detecting a presented media sequence.

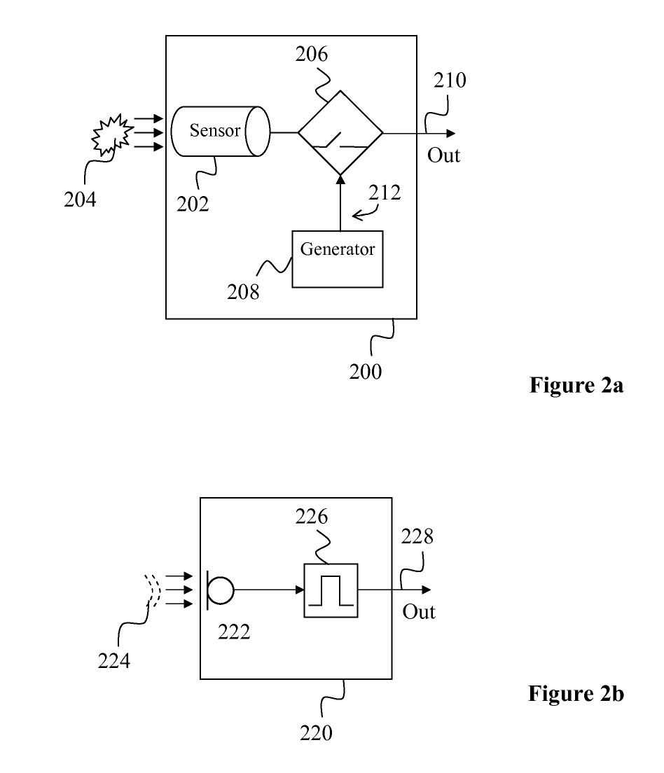

With reference to FIG. 2a, a “light-to-audio converter” will now be described, the figure schematically illustrating an exemplifying circuit diagram. For detecting a marker sequence (artificial video) in a presented modified video sequence, and for converting the marker sequence into an artificial audio sequence, a light-to-audio converter 200 might be applied. The light-to-audio converter 200 comprises an optical sensor 202, a switch 206, an audio generator 208, and a signal output 210. The optical sensor 202 is sensitive to light and is adapted to detect a light flash 204. For example, the light flash 204 may be an optical marker suitable to be detected by the sensor 202.

Furthermore, the optical sensor 202 and the optical switch 206 may alternatively be one and the same unit, implemented as e.g. an opto-switch, or an optocoupler. The audio generator 208 generates an artificial audio signal 212 on an output. When the optical sensor 202 detects a light flash 204, the optical switch 206 connects an output of the audio generator 208 to the signal output 210, thereby feeding the audio signal 212 to the signal output 210.

With reference to FIG. 2b, a “sound-to-audio converter” will be described, the figure schematically illustrating an exemplifying circuit diagram. For extracting an artificial audio sequence from a presented audio sequence, a “sound-to-audio converter” 220 could be applied. In its most generalised form, the sound-to-audio converter 220 comprises a microphone 222, a filter 226, and an output 228. The microphone 222 picks up sound 224 from the environment and converts it into an audio signal. The audio signal is then fed to an input of the filter 226, the filter 226 being sensitive to a specific audio sequence. For instance, the specific audio sequence (artificial audio) may be a burst or a specific frequency in the audio signal. When the specific audio sequence is present in the audio signal, the filter 226 allows the specific audio sequence to pass and feeds it to the signal output 228.

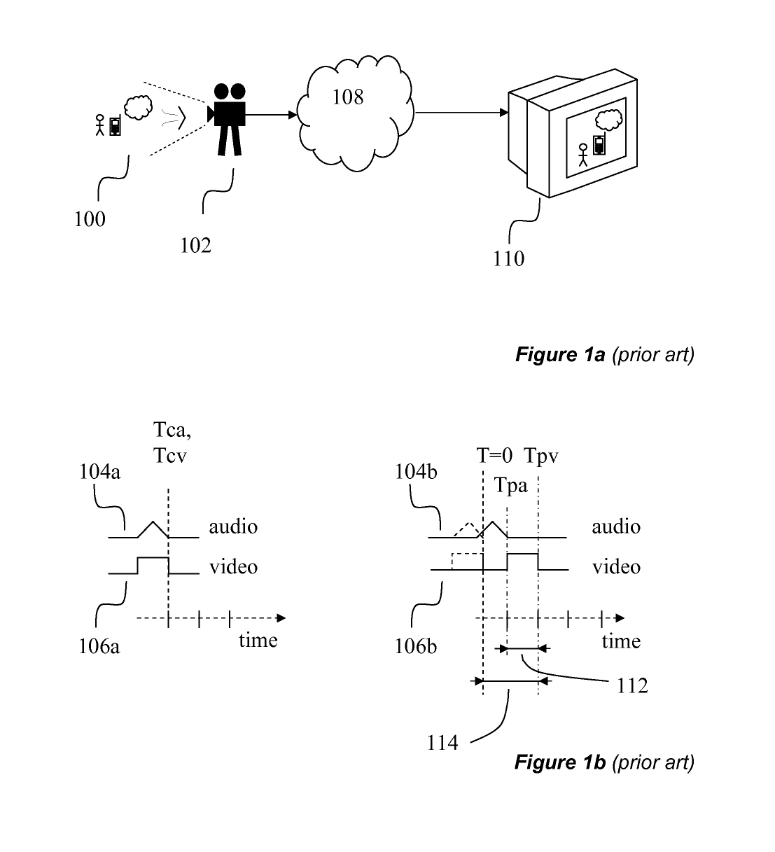

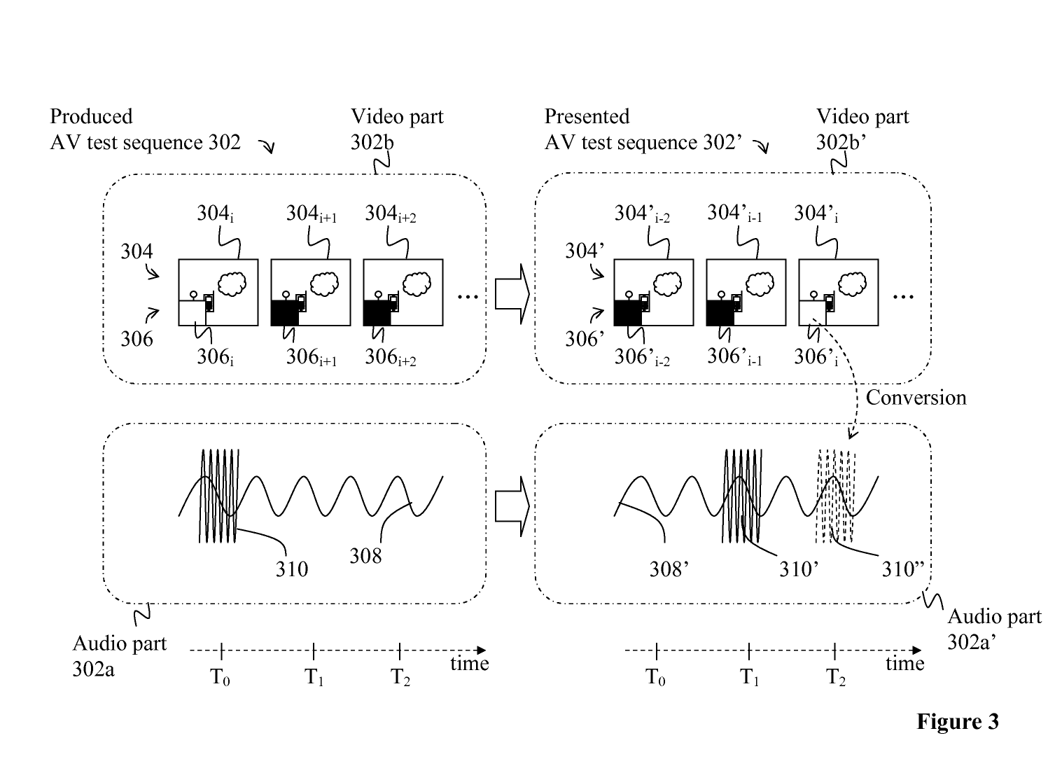

With reference to FIG. 3 and further reference to FIG. 1, a procedure for determining audio-video skew in accordance with one embodiment will now be described. FIG. 3 illustrates schematically an audio-video test sequence 302 produced in a capturing device 102, and a corresponding delayed audio-video test sequence 302′ presented in a presentation device 110. The audio-video test sequence 302 is transmitted from the capturing device 102 to the presentation device 110 over a transmission path 108, and the delay of the audio sequence 302, 302′ is due to e.g. various signal processing and propagation during the transmission.

The audio-video test sequence 302 comprises an audio part 302a and a video part 302b. The audio part 302a of the audio-video test sequence 302 is produced by adding an artificial audio sequence 310 to a captured audio sequence 308. The video part 302b of the audio-video test sequence 302 is produced by providing a captured video sequence 304 comprising a series of image frames { . . . , 304ᵢ, 304ᵢ₊₁, 304ᵢ₊₂, . . . } with a marker sequence 306 comprising a series of markers { . . . , 306ᵢ, 306ᵢ₊₁, 306ᵢ₊₂, . . . }, and creating a modified video sequence 304/306 comprising a series of modified image frames { . . . , 304ᵢ/306ᵢ, 304ᵢ₊₁/306ᵢ₊₁, 304ᵢ₊₂/306ᵢ₊₂, . . . }. The audio sequence 308 represents the sound corresponding to the video sequence 304, and the marker sequence 306 represents the added artificial audio sequence 310. For the reasons stated above, the audio-video test sequence 302 is delayed when being transmitted. In general, transport in the video domain is more affected by delays than in the audio domain, when transmitting audio-video information over a transmission network.

At the audio-video presentation device 110, the delayed audio-video test sequence 302′ is presented after being received. The presented audio-video test sequence 302′ comprises a video part 302b′ and an audio part 302a′, and the audio-video test sequence 302′ is affected by delays both in the audio domain and in the video domain. In this embodiment, the audio part 302a′ of the audio-video test sequence 302′ corresponds to the audio part 302a of the audio-video test sequence 302, delayed by a time period corresponding to one image frame. Furthermore, the audio part 302a′ of the presented audio-video test sequence 302′ comprises an audio sequence 308′ corresponding to the captured audio sequence 308, and an artificial audio sequence 310′ corresponding to the added artificial sequence 310.

In this embodiment, the video part 302b′ of the presented audio-video test sequence 302′ corresponds to the video part 302b of the produced audio-video test sequence 302, delayed by a time period corresponding to two image frames. This means that the modified image frame 304′ᵢ/306′ᵢ received at the time T₂ corresponds to the modified image frame 304ᵢ/306ᵢ transmitted at the time T₀, and that the modified image frame 304′ᵢ₋₂/306′ᵢ₋₂ received at the time T₀ corresponds to a modified image frame (not shown) transmitted a time period corresponding to two image frames earlier than the time T₀. Furthermore, at the presentation device 110, the video part 302b′ of the presented audio-video test sequence 302′ is registered to detect a marker 306′ᵢ in a received modified image frame 304′ᵢ/306′ᵢ. The marker 306′ᵢ indicates that the corresponding modified image frame 304ᵢ/306ᵢ at the capturing device 102 was provided with a marker 306ᵢ, due to an artificial audio sequence 310. When a marker 306′ᵢ is detected in a modified image frame 304′ᵢ/306′ᵢ in the video part 302b′ of the audio-video test sequence 302′, the marker 306′ᵢ is converted into an artificial audio sequence 310″ (illustrated by a dashed arrow). Finally, the generated artificial audio sequence 310″ is compared to the presented artificial audio sequence 310′, and the time difference between the artificial audio sequences 310″ and 310′ is measured. The generated artificial audio sequence 310″ is illustrated as a dashed line, because it does not belong to the audio part 302a′.

By representing the artificial audio sequence 310 with the marker sequence 306 (artificial video), transmitting the marker sequence 306, presenting the received marker sequence 306, and converting the presented delayed marker sequence 306′ into the received artificial audio sequence 310″, the artificial audio sequence 310 can be considered to be transmitted in the video domain. Therefore, by comparing the presented artificial audio sequence 310′ transmitted in the audio domain to the artificial audio sequence 310″ transmitted in the video domain, the audio-video skew 112 can be calculated.

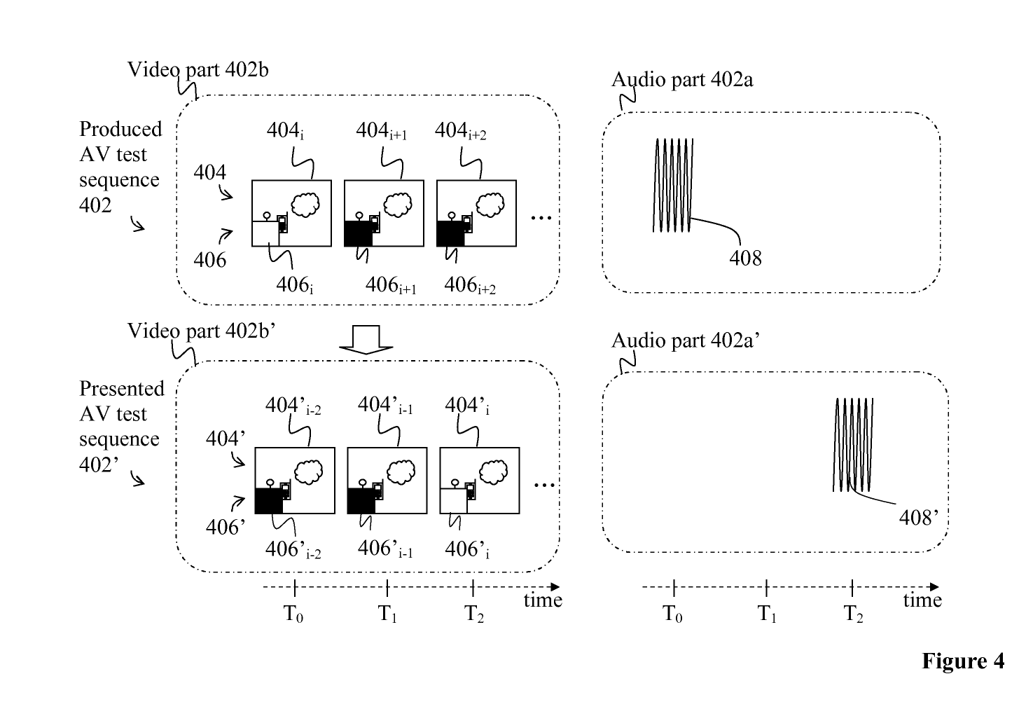

With reference to FIG. 4 and further reference to FIG. 1, a procedure for determining the End-to-End delay for a transmitted video sequence in accordance with another embodiment will now be described. FIG. 4 schematically illustrates an audio-video test sequence 402 produced at an audio-video capturing device 102, and a corresponding audio-video test sequence 402′ received and presented at an audio-video presentation device 110. The produced audio-video test sequence 402′ comprises an audio part 402a and a video part 402b. Correspondingly, the presented audio-video test sequence 402 comprises an audio part 402a′ and a video part 402b′.

The video part 402b of the produced audio-video test sequence 402 is produced by providing a video sequence 404 comprising a series of image frames { . . . , 404ᵢ, 404ᵢ₊₁, 404ᵢ₊₂, . . . } with a marker sequence 406 comprising a series of markers { . . . , 406ᵢ, 406ᵢ₊₁, 406ᵢ₊₂, . . . }, and creating a modified video sequence 404/406 comprising a series of modified image frames { . . . , 404ᵢ/406ᵢ, 404ᵢ₊₁/406ᵢ₊₁, 404ᵢ₊₂/406ᵢ₊₂, . . . }. The video part 402b of the produced audio-video test sequence 402 is conveyed over a transmission path 108 to an audio-video presentation device 110. Furthermore, the video part 402b is presented at presentation unit (not shown) of the capturing device 102.

At the audio-video presentation device 110 a video part 402b′ of an audio-video test sequence 402′ is presented, the video part 402b′ corresponding to the produced video part 402b of the produced audio-video test sequence 402. However, due to e.g. various processing and buffering functions performed on the video part 402b of the audio-video sequence 402, the presented video part 402b′ of the audio-video test sequence 402′ is affected by delay. In this embodiment, the presented video part 402b′ of the audio-video test sequence 402′ corresponds to the video part 402b of the produced audio-video test sequence 402, delayed by a time period corresponding to two image frames. This means that the modified image frame 404′ᵢ/406′ᵢ, presented at the time T₂, corresponds to the modified image frame 404ᵢ/406ᵢ produced at the time T₀, and that the modified image frame 404′ᵢ₋₂/406′ᵢ₋₂ presented at the time T₀ corresponds to a modified image frame (not shown) produced a time period corresponding to two image frames earlier than the time T₀. The modified image frames are thus delayed in the video domain during transmission by a time period T₂−T₀.

The audio parts 402a and 402a′ are generated from the produced video part 402b and the presented video part 402b′, respectively. At the capturing device 102, the video part 402b of the produced audio-video test sequence 402 is registered to detect a marker 406i in a modified image frame 404ᵢ/406ᵢ. When a marker 406ᵢ is detected, an artificial audio sequence 408 is generated. Analogously to the process described above, at the presentation device 110, an artificial audio sequence 408′ is generated when a marker 406′ᵢ is detected in the modified image frame 404′ᵢ/406′ᵢ. Furthermore, as described for the embodiment above, even if the markers shown in FIG. 4 are implemented as white and black squares, other markers may also be used.

Although a procedure for determining the End-to-End delay for a transmitted video sequence is described in this exemplary embodiment, the invention is not limited hitherto. The described procedure can easily, as is realized by one skilled in the art, be adapted to be applied to any multimedia sequence, comprising a plurality of media sequences of one or more media types.

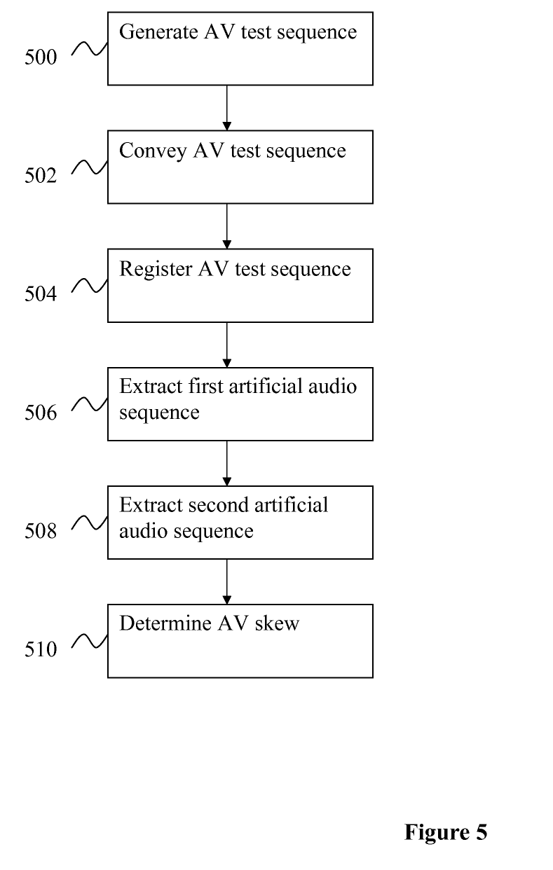

A method of determining audio-video time skew when conveying audio-video information over a transmission path, in accordance with another exemplary embodiment will now be described with reference to FIG. 5, illustrating a flow chart with steps executed in an audio-video capturing device and an audio-video presentation device. In a first step 500, executed in the audio-video capturing device, an audio-video test sequence (denoted as AV test sequence in the figure) is generated, the audio-video test sequence comprising an audio part and a video part. In this step, a sound sequence and an image sequence from a scene are captured by the audio-video capturing device, which outputs an audio sequence and a video sequence, representing the captured sound sequence and the captured image sequence, respectively, of the scene. The outputted audio sequence and the outputted video sequence are hereinafter referred to as the captured audio sequence, and the captured video sequence, respectively. The audio part of the audio-video test sequence is then formed by generating and adding an artificial audio sequence to the audio sequence. The artificial audio sequence may be implemented as an audio burst, or any other audio sequence distinguishable from the captured audio sequence.

Correspondingly, the video part of the audio-video test sequence is formed by generating and adding a marker sequence (artificial video) to the video sequence. The markers of the marker sequence may be implemented as coloured squares, or any other visible or non-visible markers, as described above.

Then, in a next step 502 the generated audio-video test sequence is conveyed from the audio-video capturing device to the audio-video presentation device. As outlined above, the audio part and the video part of the audio-video test sequence may typically be affected by various delays. Generally, the audio part arrives to the audio-video presentation device before the video part, the difference between arrival times being the audio-video time skew to be determined. The received audio-video test sequence is then, in a following step 504, registered after being presented by the audio-video presentation device. The video part may be displayed as an image sequence by an image presentation unit, and the audio part may be emitted as a sound sequence by a loudspeaker.

In a further step 506, executed at the audio-video presentation device, an artificial audio sequence in the audio part of the presented audio-video test sequence is extracted, corresponding to the artificial audio sequence added in step 500. For registering the emitted sound sequence in step 504, and for extracting the artificial audio sequence in step 506, a sound-to-audio converter may be employed, as shown in FIG. 2b. In a further step 508, executed at the audio-video presentation device, another artificial audio sequence is generated, different from the artificial audio sequence extracted in step 506. The generation is performed by detecting a marker sequence (artificial video) in the video part of the registered audio-video test sequence, and when the marker sequence is present generating the artificial audio sequence, the detected marker sequence corresponding to the marker sequence added in step 500. For registering the displayed image sequence in step 504, and for generating the artificial audio sequence, a light-to-audio converter may be employed, as shown in FIG. 2a. Finally, in step 510, the artificial audio sequence extracted in step 506, and the artificial audio sequence generated in step 508, are compared and the time difference between them is determined as the audio-video time skew.

Although a method for determining an audio-video time skew is described in this exemplary embodiment, the invention is not limited hitherto. The described method can easily, as is realized by one skilled in the art, be adapted to be applied on any multimedia sequence, comprising a plurality of media sequences of one or more media types.

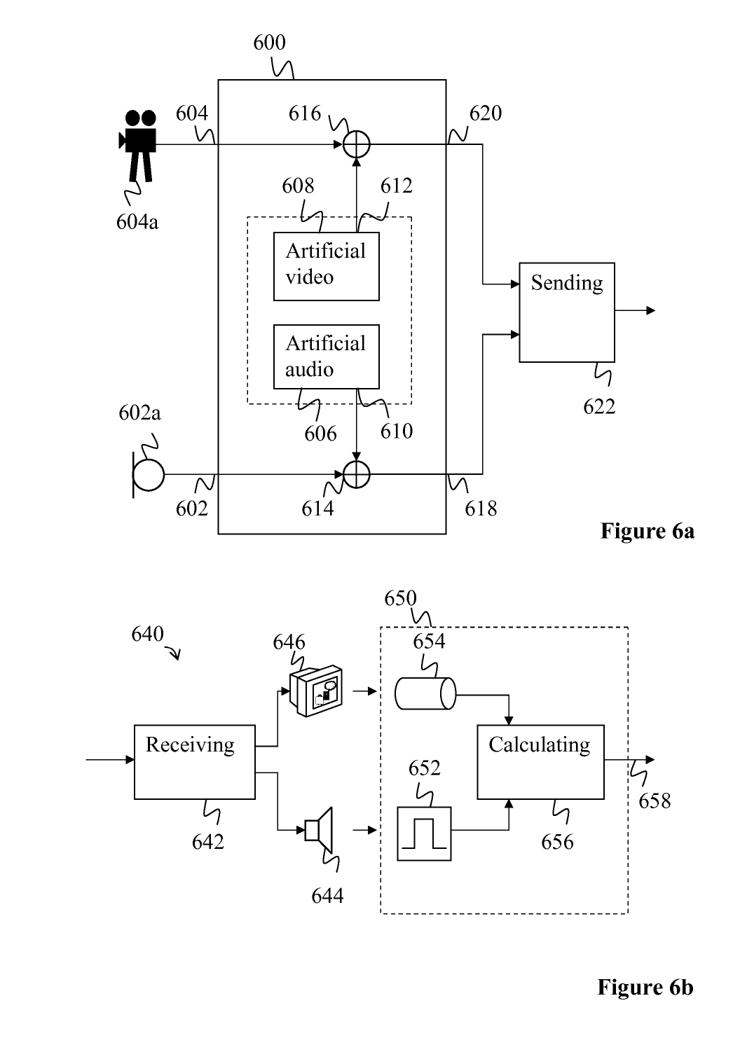

With reference to FIGS. 6a and 6b, an embodiment of an arrangement for determining audio-video time skew when conveying audio-video information over a transmission path will now be described. The arrangement comprises an audio-video test sequence generator 600 adapted to generate an audio-video test sequence, and an audio-video time skew determination device 650 adapted to determine an audio-video time skew. The audio-video test sequence generator 600 comprises an audio input 602 adapted to receive a captured audio sequence from a sound capturing device 602a, and a video input 604 adapted to receive a captured video sequence from a video capturing unit 604a. The audio-video test sequence generator 600 further comprises an audio output 618 adapted to feed an audio part of the generated audio-video test sequence to a sending unit 622. Moreover, the audio-video test sequence generator 600 comprises a video output 620 adapted to feed a video part of the audio-video test sequence to the sending unit 622.

Furthermore, the audio-video test sequence generator 600 comprises an artificial audio generator 606 adapted to generate an artificial audio sequence on one of its outputs 610 and add it to the captured audio sequence. In this embodiment an audio adding unit 614 is employed to add the artificial audio sequence on the output 610 to the captured audio sequence on the audio input 602, resulting in the audio part of the audio-video test sequence on the audio output 618. Correspondingly, the audio-video test generator 600 comprises an artificial video generator 608 adapted to generate an artificial video sequence on one of its outputs 612 and add it to the captured video sequence. In this embodiment, a video adding unit 616 is employed to add the artificial video sequence on the output 612 to the captured video sequence on the video input 604, resulting in the video part of the audio-video test sequence on the video output 620.

However, any other suitable units for adding audio sequences or video sequences, respectively, may be employed in the manner described. Additionally, the artificial audio generator 606 and the artificial video generator 608 may be provided in an integrated unit (illustrated with a dashed rectangle).

The sending unit 622 is adapted to receive the audio part and the video part of the audio-video test sequence, and convey the audio-video test sequence over a transmission path to an audio-video presentation device 640. However, a person skilled in the art will realize that any of an audio capturing unit 602a, a video capturing unit 604a, or the sending unit 622, may be integrated in the audio-video test sequence generator 600.

The audio-video presentation device 640 is adapted to receive and present the audio-video test sequence sent by the sending unit 622. However, due to reasons outlined above, the received audio-video test sequence is affected by various delays. The audio-video presentation device 640 according to this embodiment comprises a receiving unit 642 adapted to receive the conveyed audio-video test sequence and separate it into an audio part and a video part, respectively. The audio-video presentation device 640 is further provided with an audio presentation unit 644, e.g. a loudspeaker, adapted to emit a sound sequence representing the audio part of the received audio-video test sequence, and a video presentation unit 646, e.g. a display or a monitor screen, adapted to display an image sequence representing the video part of the received audio-video test sequence. The audio-video presentation device 640 may be a mobile communication terminal, a computer connected to a communication network, or any other suitable audio-video presentation device, being adapted to receive an audio-video sequence over a transmission path and being further adapted to present an audio part and a video part, respectively, of the received audio-video sequence.

The audio-video time skew determination device 650 comprises an artificial audio sensor 652, an artificial video sensor 654, a calculation unit 656 and an output 658. The artificial audio sensor 652 is adapted to register the sound sequence emitted by the audio-video presentation device 640, and further adapted to filter out an audio sequence representing the artificial audio sequence added by the audio-video test sequence generator 600. The artificial audio sensor 652 further comprises an output adapted to feed the out-filtered artificial audio sequence to an input of the calculation unit 656. The artificial audio sensor 652 may be implemented as a sound-to-audio converter, as shown in FIG. 2b.

The artificial video sensor 654 is adapted to register the image sequence displayed by the audio-video presentation device 640, and further adapted to detect an artificial video sequence representing the artificial video sequence added by the audio-video test sequence generator 600. Furthermore, the artificial video sensor 654 is adapted to convert the detected artificial video sequence into another artificial audio sequence (different from the one output from the artificial audio sensor 652) and to feed the converted audio-video sequence to the calculation unit 656. The artificial video sensor 654 can be implemented as a light-to-audio converter, as shown in FIG. 2a. Additionally, the artificial audio sensor 652 and the artificial video sensor 654 may be provided in an integrated unit (not shown).

The calculating unit 656 is adapted to compare the received artificial audio sequences on its inputs and calculate the time difference between them, defined as the audio-video time skew. The calculating unit 656 is provided with an output 658, adapted to output a signal representing the audio-video time skew, which could then be presented to a user in a suitable manner. For presenting the determined audio-video time skew, the output 658 of the audio-video time skew determination device 650 is adapted to be connected to any presentation means (not shown), being suitable for presenting the determined audio-video time skew to a person or an apparatus and the invention is not limited in this respect. Such presentation units may, for instance, be a display, a stereophonic earphone, any unit adapted to present a combination of visible and audible information, etc.

Additionally, the presentation unit may be integrated in the audio-video time skew determination device 650. Furthermore, in addition, the audio-video presentation device 640 and the audio-video time skew determination device 650 may be provided in an integrated device.

Although an arrangement for determining audio-video time skew when conveying audio-video information over a transmission path is described in this exemplary embodiment, the invention is not limited hitherto. The described arrangement can easily, as is realized by one skilled in the art, be adapted to be applied to determine skew between any two media sequences in a multimedia sequence.

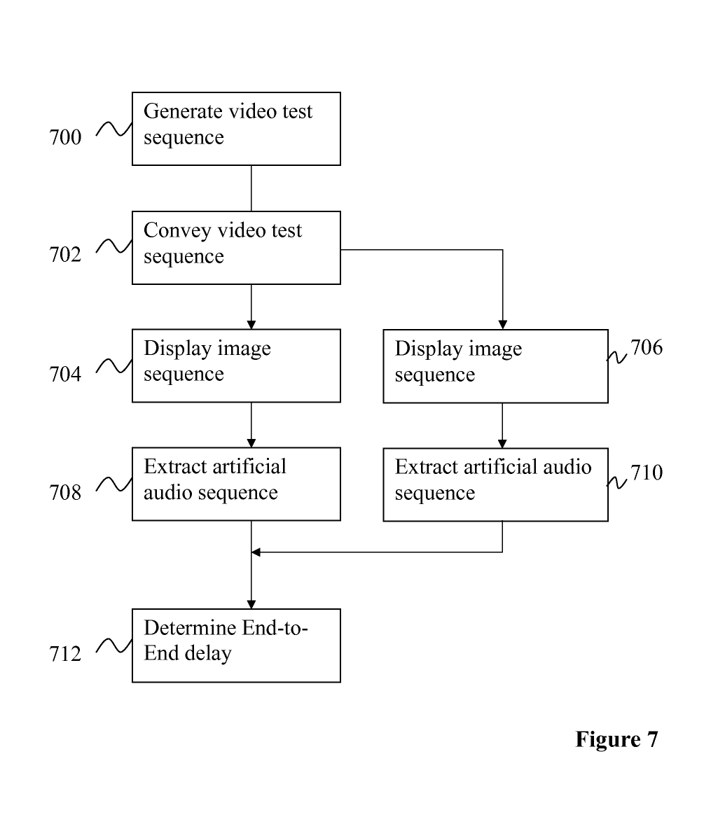

A method of determining End-to-End delay when conveying video information over a transmission path, in accordance with another exemplary embodiment will now be described with reference to FIG. 7, illustrating a flow chart with steps executed in a video test sequence generator and a video End-to-End determination device. In a first step 700, executed in the video test sequence generator, a video test sequence is generated. In this step, an image sequence from a scene are captured by a video capturing device, which outputs a captured video sequence, representing the captured image sequence. The video test sequence is then formed by generating and adding a marker sequence (artificial video) to the captured video sequence. The markers of the marker sequence may be implemented as coloured squares, or any other visible or non-visible markers, as described above.

Then, in a next step 702 the generated video test sequence is conveyed from the video test sequence generator to a video presentation device. As outlined above, the video test sequence is typically affected by various delays. The generated video test sequence is then, in a following step 704, displayed as an image sequence by a presentation unit of the video test sequence generator. Correspondingly, in a further step 706, executed in the video presentation device, the video test sequence is displayed as an image sequence by a presentation unit, when received.

In a further step 708, executed in the video End-to-End determining device, the image sequence presented by the video test sequence generator is registered. Then an artificial audio sequence is generated. The generation is performed by detecting a marker sequence (artificial video) in the registered video test sequence, and when the marker sequence is present generating the artificial audio sequence, the detected marker sequence corresponding to the marker sequence added in step 700. Correspondingly, in a further step 710, executed in the video End-to-End determination device, the image sequence presented by the video presentation device is registered. Then an artificial audio sequence is generated, different from the artificial audio sequence generated in step 708.

For registering the displayed image sequences in step 708 and 710, and for generating the artificial audio sequences, light-to-audio converters may be employed, as shown in FIG. 2a. Finally, in step 712, the artificial audio sequence extracted in step 708, and the artificial audio sequence generated in step 710, are compared and the time difference between them is determined as the video End-to End delay.

Although a method for determining a video End-to-End delay is described in this exemplary embodiment, the invention is not limited hitherto. The described method might be applied to any media sequence included in a multimedia sequence, comprising a plurality of media sequences of one or more media types, e.g. an audio sequence.

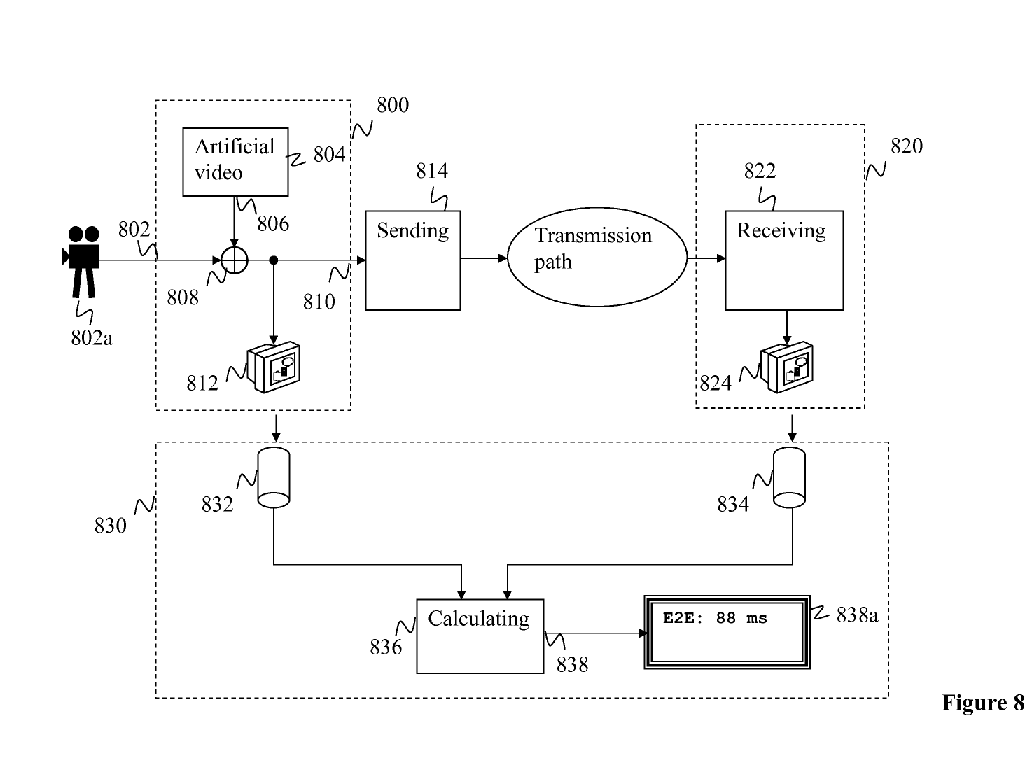

With reference to FIG. 8, an embodiment of an arrangement for determining End-to-End delay when conveying video information over a transmission path will now be described. The arrangement comprises a video test sequence generator 800 adapted to generate a video test sequence, and a video End-to-End delay determination device 830 adapted to determine a video End-to-End delay. The video test sequence generator 800 comprises a video input 802 adapted to receive a captured video sequence from an image capturing device 802a. The video test sequence generator 800 further comprises a video output 810 adapted to feed the generated video test sequence to a sending unit 814.

Furthermore, the video test sequence generator 800 comprises an artificial video generator 804 adapted to generate an artificial video sequence on one of its outputs 806 and add it to the captured video sequence. In this embodiment a video adding unit 808 is employed to add the artificial video sequence on the output 806 to the captured video sequence on the video input 802, resulting in the video test sequence on the audio output 810. However, any other suitable units for adding video sequences may be employed in the manner described. Moreover, the video test sequence generator comprises a video presentation unit 812 (e.g. a display or a monitor screen), adapted to display the video test sequence.

The sending unit 814 is adapted to receive the video test sequence, and convey it over a transmission path to a video presentation device 820. However, a person skilled in the art will realize that any of a video capturing unit 802a or the sending unit 814, may be integrated in the video test sequence generator 800.

The video presentation device 820 is adapted to receive and display the video test sequence sent by the sending unit 814. However, due to reasons outlined above, the received video test sequence is affected by various delays. The video presentation device 820 according to this embodiment comprises a receiving unit 822 adapted to receive the conveyed video test sequence, and a video presentation unit 824 (e.g. a display or a monitor screen) adapted to display an image sequence representing the video test sequence. The video presentation device 820 may be a mobile communication terminal, a computer connected to a communication network, or any other suitable video presentation device, being adapted to receive a video sequence over a transmission path and being further adapted to display the received video sequence.

The video End-to-End delay determination device 830 comprises first video sensor 832, a second video sensor 834, a calculation unit 836 and an output 838. The first video sensor 832 is adapted to register the image sequence displayed by the video presentation unit 812, and further adapted to detect an artificial video sequence representing the artificial video sequence added by the video test sequence generator 800. Correspondingly, the second video sensor 834 is adapted to register the image sequence displayed by the video presentation unit 824, and further adapted to detect an artificial video sequence representing the artificial video sequence added by the video test sequence generator 800. Furthermore, the artificial video sensors 832 and 834 are adapted to convert the detected artificial video sequences, respectively, into artificial audio sequences and feed the converted sequences to the calculation unit 836. The artificial video sensors 832 and 834 can be implemented as light-to-audio converters, as shown in FIG. 2a.

The calculating unit 836 is adapted to compare the received artificial audio sequences and calculate the time difference between them, defined as the video End-to-End delay. The calculating unit 836 is provided with an output 838, adapted to output a signal representing the video End-to-End delay, which could then be presented to a user in a suitable manner. For presenting the determined video End-to-End delay, the output 838 of the audio-video time skew determination device 830 is adapted to be connected to any presentation means 838a, being suitable for presenting the determined video End-to-End delay to a person or an apparatus and the invention is not limited in this respect. Such presentation units may, for instance, be a display, a stereophonic earphone, etc.

Additionally, the presentation unit may be integrated in the video End-to-End delay determination device 830.

Although an arrangement for determining End-to-End delay when conveying video information over a transmission path is described in this exemplary embodiment, the invention is not limited hitherto. The described arrangement can easily, as is realized by one skilled in the art, be adapted to be applied to determine End-to-End delay of any media sequence included in a multimedia sequence.

By the present invention an accurate and relatively less complex method for time skew determination and End-to-End delay is obtained, also providing information of time delays of capturing and presentation units. Using the above described solution, the time skew and the End-to-End delay can be performed for different types of multimedia sequences, typically being affected by delays of various amounts.

Moreover, it is not necessary to analyse the video signals for determining the time skew, which is otherwise complicated and requires large amount of processing capacity.

While the invention has been described with reference to specific exemplary embodiments, the description is in general only intended to illustrate the inventive concept and should not be taken as limiting the scope of invention. Although audio-video sequences have been used throughout when describing the above embodiments, any other multimedia sequences comprising synchronised information in one or a plurality of media types, and being affected by delays when conveyed, may be used in the manner described.

The invention is generally defined by the following independent claims.

1-25. (canceled)

26. A method for determining a time skew between a first media sequence and a second media sequence, said media sequences being conveyed from a sending party to a receiving party over a transmission path, comprising the following step being executed at the sending party:
generating a test sequence comprising a first part and a second part, wherein the first part comprises a first captured media sequence and a first artificial media sequence, and the second part comprises a second captured media sequence and a second artificial media sequence;
said method further comprising the following steps being executed at the receiving party:
receiving the test sequence and registering the received test sequence when presented on a presentation device, wherein the first part of the received test sequence is affected by a first delay and the second part of the received test sequence is affected by a second delay;
extracting the first artificial media sequence from the first part of the received test sequence, and extracting the second artificial media sequence from the second part of the received test sequence; and
determining the time skew based on a time difference between the extracted first artificial media sequence and the extracted second artificial media sequence.

27. A method for determining a time skew between a first media sequence and a second media sequence, said media sequences being conveyed from a sending party to a receiving party over a transmission path, said method comprising the following steps being executed at the sending party:
generating a first artificial media sequence;
adding the first artificial media sequence to a first captured media sequence, resulting in a first modified media sequence;
generating a second artificial media sequence;
adding the second artificial media sequence to a second captured media sequence, resulting in a second modified media sequence;
said method further comprising the following steps being executed at the receiving party:
registering the first modified media sequence when presented, and extracting the first artificial media sequence from the registered first modified media sequence;
registering the second modified media sequence when presented, and extracting the second artificial media sequence from the registered second modified media sequence;
calculating a time difference between when the first artificial media sequence is presented and when the second artificial media sequence is presented as the time skew; and
presenting the time skew to a user.

28. The method according to claim 27, wherein the media type of the first artificial media sequence is different from the media type of the second artificial media sequence, and the method further comprises converting the extracted second artificial media sequence into the same media type as the first artificial media sequence before calculating the time difference.

29. The method according to claim 28, wherein the media type of the first artificial media sequence is audio and the media type of the second artificial media sequence is video.

30. The method according to claim 28, wherein the second artificial media sequence is implemented as a sequence of detectable markers selected from a set of: a colored square, a colored line, a colored frame, and a pattern comprising some predefined pixels.

31. The method according to claim 28, wherein the first artificial media sequence is implemented as an audio burst and the extracted second artificial media sequence is converted into an audio burst.

32. The method according to claim 27, wherein the media type of the first artificial media sequence is the same as the media type of the second artificial media sequence.

33. An apparatus for determining a time skew between a first media sequence and a second media sequence, said media sequences being conveyed from a sending party to a receiving party over a transmission path, wherein said apparatus comprises:
a test sequence generator at the sending party; and
a time skew determination device at the receiving party;
wherein the test sequence generator comprises:
a first media sequence generator configured to generate a first artificial media sequence; and
a second media sequence generator configured to generate a second artificial media sequence;
said test sequence generator being further configured to add the first artificial media sequence to a first captured media sequence resulting in a first modified media sequence, and to add the second artificial media sequence to a second captured media sequence resulting in a second modified media sequence; and
wherein the time skew determination device comprises:
a first sensor configured to receive the first modified media sequence and to register the first modified media sequence when presented, and to extract the first artificial media sequence from the registered first modified media sequence; and
a second sensor configured to receive the second modified media sequence and to register the second modified media sequence when presented, and to extract the second artificial media sequence from the registered second modified media sequence;
a calculation unit configured to calculate a time difference between when the first artificial media sequence is presented and when the second artificial media sequence is presented as said time skew, and further configured to present the calculated time skew to a user.

34. The apparatus according to claim 33, wherein the media type of the second artificial media sequence is different from the media type of the first artificial media sequence, and the second sensor is further configured to convert the extracted second artificial media sequence into the same media type as the first artificial media sequence extracted by the first sensor.

35. The apparatus according to claim 33, wherein
the first media sequence generator is configured to generate the first artificial media sequence as an audio sequence;
the second media sequence generator is configured to generate the second artificial media sequence as an video sequence; and
the second sensor is configured to convert the media type of the extracted second artificial media sequence from video to audio.

36. The apparatus according to claim 35, wherein the second media sequence generator is further configured to generate the second artificial media sequence as detectable markers selected from a set of: a colored square, a colored line, a colored frame, and a pattern comprising some predefined pixels.

37. The apparatus according to claim 35, wherein the first media sequence generator is further configured to generate the first artificial media sequence as an audio burst, and the second sensor is configured to convert the extracted second artificial media sequence from a video sequence into an audio burst.

38. The apparatus according to claim 33, wherein the media type of the second artificial media sequence is the same as the media type of the first artificial media sequence.

39. A method for determining an End-to-End delay for a media sequence being conveyed from a sending party to a receiving party over a transmission path, comprising the following steps being executed at the sending party:
generating an artificial media sequence;
adding the generated artificial media sequence to a captured media sequence to
generate a modified media sequence;
presenting the modified media sequence;
registering the modified media sequence when presented, and extracting the
presented artificial media sequence from the registered modified media sequence;
the method further comprising the following steps being executed at a receiving party:
receiving the modified media sequence and registering the modified media sequence when presented, and extracting the received and presented artificial media sequence from the registered media sequence;
calculating the time difference between the presented artificial media sequence and the received and presented artificial media sequence as the End-to-End delay; and
presenting the calculated End-to-End delay to a user.

40. The method according to claim 39, wherein the media type of the presented artificial media sequence and the received and presented artificial media sequence is different from the media type of the generated artificial media sequence, and the method further comprises the following step at the sending party:
converting the presented artificial media sequence into the same media type of
the generated artificial media sequence; and
the following step at the receiving party:
converting the received and presented artificial media sequence into the same media type of the generated artificial media sequence.

41. The method according to claim 40, wherein the media type of the generated artificial media sequence is video and the media type of the presented artificial media sequence and the received and presented artificial media sequence is audio.

42. The method according to claim 41, wherein the generated artificial media sequence is implemented as a sequence of detectable markers selected from a set of: a colored square, a colored line, a colored frame, and a pattern comprising some predefined pixels.

43. The method according to claim 41, wherein the presented artificial media sequence and the received and presented artificial media sequence are implemented as an audio burst.

44. The method according to claim 39, wherein the media type of the presented artificial media sequence and the received and presented artificial media sequence are the same as the media type of the generated artificial media sequence.

45. An apparatus for determining an End-to-End delay for a media sequence being conveyed from a sending party to a receiving party over a transmission path, comprising:
a test sequence generator at the sending party; and
an End-to-End delay determination device;
wherein the test sequence generator comprises:
a media sequence generator configured to generate an artificial media sequence; and
a presentation unit configured to present a modified media sequence;
the test sequence generator being further configured to add the generated artificial media sequence to a captured media sequence resulting in the modified media sequence; and
wherein the End-to-End delay determination device comprises:
a first sensor configured to register the modified media sequence when presented at the sending party, and to extract the artificial media sequence from the registered modified media sequence as the first extracted artificial media sequence;
a second sensor configured to register the modified media sequence when presented at the receiving party, and to extract the artificial media sequence from the registered modified media sequence as the second extracted artificial media sequence; and
a calculation unit configured to calculate a time difference between when the artificial media sequence is presented at the receiving party and when the artificial media sequence is presented at the sending party as said End-to-End delay, and further configured to present the calculated End-to-End delay to a user.

46. The apparatus according to claim 45, wherein the sensors are further configured to convert the first and second extracted artificial media sequences, respectively, into a media type different from the media type of the generated artificial media sequence.

47. The apparatus according to claim 45, wherein
the media sequence generator is configured to generate the generated artificial media sequence as a video sequence;
the first sensor is configured to detect the first extracted artificial media sequence as a video sequence and convert it into an artificial audio sequence; and
the second sensor is configured to detect the second extracted artificial media sequence as a video sequence and convert it into an artificial audio sequence.

48. The apparatus according to claim 47, wherein the media sequence generator is further configured to implement the generated artificial media sequence as detectable markers selected from a set of: a colored square, a colored line, a colored frame, and a pattern comprising some predefined pixels.

49. The apparatus according to claim 47, wherein the first sensor is further configured to implement the first extracted artificial media sequence as an audio burst, and the second sensor is further configured to implement the second extracted artificial media sequence as an audio burst.

50. The apparatus according to claim 45, wherein the media type of the first and second extracted artificial media sequences is the same media type of the generated artificial media sequence.
